(19) United States
(12) Patent Application Publication
(10) Pub. No.: US 2025/0000024 A1
(43) Pub. Date: Jan. 2, 2025

(54) CORN EAR SIZE DETECTION

(71) Applicant: DEERE & COMPANY, Moline, IL (US)

(72) Inventors: Nathan R. Vandike, Geneseo, IL (US); Duane M. Bomleny, Geneseo, IL (US)

(21) Appl. No.: 18/216,831

(22) Filed: Jun. 30, 2023

(51) Int. Cl. A01D 41/127

(52) U.S. Cl. CPC A01D 41/1277

(57) ABSTRACT

An agricultural machine including a plurality of grain processing devices, wherein each of the grain processing devices is adapted to process crop material and each of the grain processing devices includes an actuator to adjust a position the processing device. One or more imaging devices are each adapted to image crop material at one or more of the plurality of processing devices. A controller is operatively connected to the imaging device and to at least one of the actuators. The controller is configured to image the crop material to identify characteristics of the imaged crop material and/or imaged non-grain material, to identify grain elements and non-grain elements, determine a position of one of the plurality of processing devices, and adjust the position of the one of the plurality of processing devices based on the identified grain elements or identified non-grain elements.

### FIELD OF THE DISCLOSURE

The present disclosure relates to an agricultural machine and, more particularly, to an agricultural machine for harvesting grain.

### BACKGROUND

Agricultural machines, such as a tractor or a self-propelled harvester, include mechanical systems, electrical systems, hydraulic systems, and electro-hydraulic systems. One type of agricultural machine includes a self-propelled harvester having different systems for cutting crop and moving the crop through the harvester. In a harvester for corn, for instance, the corn harvester includes a plurality of row units that receive stalks of corn. The row units include stalk rollers and deck plates that strip the ears of corn from the stalks. The stalks are discarded onto the ground, and the ears of corn are received onto a corn header. Kernels of corn or, more generally grain, are separated from the cobs and are stored in an onboard storage bin for later unloading from the harvester.

Combine harvesters harvest crops which are gathered from the field, threshed-out, and separated. The crops obtained by threshing are subsequently separated from undesired crop residues by a cleaning process. The threshing process removes the grain, typically a kernel, from the supporting stalk of the plant. In the case of corn, a corn husk is removed from an ear of corn and the kernels of corn are removed from a cob, after the corn husk has been removed.

The threshing process typically includes directing the cut crop to a thresher having a gap located between a rotor and a threshing basket, in the form of a fixed wire grate or a similar device. The rotor rotates with respect to the fixed grate and a sufficient amount of cut crop is forced into the gap such the rotor engages the crop to remove the kernels from the cut crop. Once removed, the kernels fall through the threshing basket to a collector that collects the grain.

After threshing, a separation process is performed. In the separation process, the rear portion of the rotor with a different configuration than the front rotates with respect to a fixed grate wherein lighter particles, such as chaff, broken parts of the stalk, leaves, and other plant materials are separated from any remaining grain. Grain and other plant material fall through the fixed grate onto one or more sieves. The cleaning process includes a blower, which acts on sieves that move back and forth. A part of the cleaning process, resulting from the air being moved by the blower, separates the lighter particles from the grain and the grain falls through the sieves where it is taken to a grain tank. Some combine harvesters utilize an upper sieve placed above a lower sieve.

Different types of combines are manufactured and perform the threshing and separating process. In an axial combine, for instance, the threshing is done by the forward part of the rotor and the threshing basket, and the separating is done by the rear part of the rotor and the grates. In a conventional agricultural machine or in a hybrid agricultural machine, the threshing is done by a lateral drum with a threshing basket, while the separating is accomplished by walkers or rotors with grates.

### SUMMARY

In one implementation there is provided an agricultural machine including a plurality of processing devices, wherein each of the processing devices is configured to process crop material including non-grain material. One or more imaging devices are each configured to image the non-grain material at one or more of the plurality of processing devices. A controller is operatively connected to the one or more imaging devices. The controller comprises a processor and a memory, wherein the memory is configured to store program instructions and the processor is configured to execute the stored program instructions to: image the non-grain material with the one or more imaging devices; identify a characteristic of the imaged non-grain material to identify non-grain material elements; determine a position of one of the plurality of processing devices; and adjust the position of the one of the plurality of processing devices based on the identified non-grain material elements and the determined position of one of the plurality of processing devices.

In some implementations, the agricultural machine includes wherein the imaged non-grain material elements comprise grain carriers.

In some implementations, the agricultural machine includes wherein the grain carriers comprise at least one of a cob, a pod, or a hull.

In some implementations, the agricultural machine includes wherein the processor is configured to execute the stored program instructions to identify at least one of a color or shades of gray ranging from black to white or to identify dimensions of the grain carriers including at least one of length, width, or diameter.

In some implementations, the agricultural machine includes wherein the processing devices comprise at least one of deck plates, a threshing basket, a sieve, or a crop residue processing device.

In some implementations, the agricultural machine includes wherein the one or more imaging devices comprises a sieve imaging device to image the grain carriers at the sieve.

In some implementations, the agricultural machine includes wherein the processor is configured to execute the stored program instructions to identify corn cob elements of the identified grain carriers.

In some implementations, the agricultural machine includes wherein the processor is configured to execute the stored program instructions to adjust a position of one or more of the deck plates, the threshing basket, or the sieve based on the identified corn cob elements.

In some implementations, the agricultural machine includes wherein the one or more imaging devices comprises a crop residue imaging device located at the crop residue processing device to image corn cob elements of the imaged grain carriers.

In some implementations, the agricultural machine includes wherein the processor is configured to execute the stored program instructions to identify the imaged corn cob elements.

In some implementations, the agricultural machine includes wherein the processor is configured to execute the stored program instructions to adjust a position of one or more of the deck plates, the threshing basket, or the sieve based on the identified corn cob elements.

In some implementations, the agricultural machine includes wherein one of the one or more imaging devices is located at a clean grain elevator to image at least one of kernels or corn cobs.

In some implementations, the agricultural machine includes wherein the processor is configured to execute the stored program instructions to identify sizes of the at least one of kernels or sizes of the corn cobs.

In some implementations, the agricultural machine includes wherein the processor is configured to execute the stored program instructions to adjust a position of a threshing basket based on at least one of the identified kernel size or the identified corn cob size.

In some implementations, the agricultural machine includes wherein the processor is configured to execute the stored program instructions to adjust the position of the deck plates processing device based on at least one of the identified kernel size or the identified corn cob size.

In another implementation, there is provided a method of adjusting processing devices of an agricultural machine to separate and clean crop material from a harvested crop. The method includes: imaging crop material including grain material and non-grain material; identifying characteristics of the non-grain material to identify the non-grain material elements; determining a position of the one or more of the processing devices of the agricultural machine; and adjusting a position of at least one of the one or more processing devices based on the identified non-grain material elements.

In some implementations, the method includes wherein the identified non-grain material elements comprise identified carrier elements based on identified dimensions.

In some implementations, the method includes wherein the identified carrier elements comprise corn cob elements, wherein the corn cob elements are identified as one of full cobs, portions of cobs, and split cobs.

In a further implementation, there is provided an agricultural machine including one or more processing devices for separating and cleaning grain. An actuator is coupled to at least one of the one or more processing devices. An imaging device is disposed at one of the one or more processing devices, wherein the imaging device configured to image crop material comprising grain material and non-grain material. A controller is operatively connected to the imaging device and to the actuator, wherein the controller is configured to: identify characteristics of the imaged grain material to identify grain material elements and the imaged non-grain material to identify non-grain material elements; determine a position of the one or more processing devices; and adjust the position of the one or more processing devices based on the identified grain material elements or the identified non-grain material elements.

In some implementations, the agricultural machine includes wherein the grain material elements comprise at least one of ears of corn or kernels of corn and the non-grain material elements comprise corn cobs.

### BRIEF DESCRIPTION OF THE DRAWINGS

The aspects of the present disclosure and the manner of obtaining them will become more apparent and the disclosure itself will be better understood by reference to the following description of the implementations of the disclosure, taken in conjunction with the accompanying drawings, wherein:

FIG. 1 is an elevational side view of an example combine harvester;

FIG. 2 illustrates a perspective view of a corn header of the combine harvester;

FIG. 3 illustrates a top-down view of a deck assembly of the corn header showing a gap between deck plates of the deck assembly,

FIG. 4 illustrates a control system including a controller to control harvesting automation systems based on images of harvested crop materials.

FIG. 5 illustrates a block diagram of a process to adjust harvesting and cleaning components based on images of crop material.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

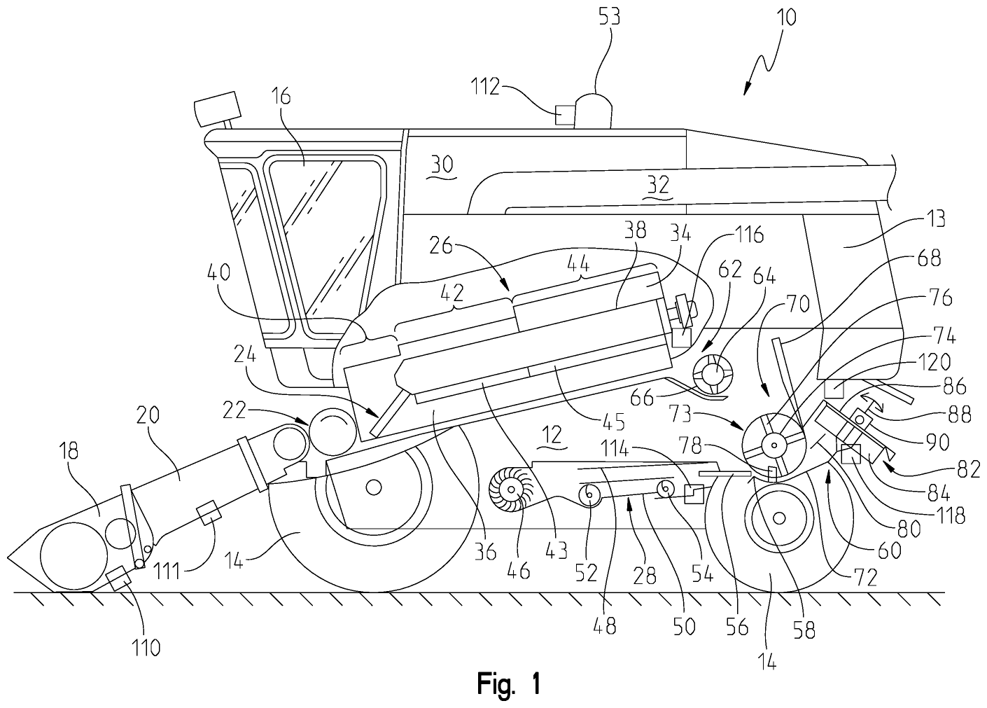

In FIG. 1, an implementation of an agricultural machine 10 is shown. The agricultural machine 10 includes a frame 12 and one or more ground engaging mechanism, such as wheels 14 or tracks, which are in contact with an underlying ground surface. In the illustrative implementation, the wheels 14 are coupled to the frame 12 and are used for propulsion of the agricultural machine 10 in a forward operating direction (which is to the left in FIG. 1) and in other directions. In some implementations, operation of the agricultural machine 10 is controlled from an operator's cab 16. The operator's cab 16 may include any number of controls for controlling the operation of the agricultural machine 10, such as a user interface. In some implementations, operation of the agricultural machine 10 may be conducted by a human operator in the operator's cab 16, a remote human operator, or an automated system.

A cutting head 18 is disposed at a forward end of the agricultural machine 10 and is used to harvest crop (such as corn) and to conduct the harvested crop to a slope conveyor 20, also known as a feederhouse. The slope conveyor 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors. A single threshing rotor 36 is shown in FIG. 1, and the threshing rotor 36 includes a drum 38. The threshing assembly 26 further includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44. The threshing assembly 26 further includes a thresher basket 43 that is positioned in the threshing section 42 and a separating grate 45 that is positioned in the separating section 44.

Harvested crop includes crop material, such as grain, e.g., corn, and non-grain material, also known as material other than grain (MOG). As used in the context of this disclosure, the value commodity of grain includes corn, wheat, legumes, soybeans, canola and other grains or seeds. Non-grain material includes stalks, leaves, stems, and husks, i.e., parts of the harvested crop that are not considered part of the value commodity of grains or seeds. The harvested crop falls through a thresher basket 43 and through a separating grate 45. The harvested crop may be directed to a clean crop routing assembly 28 with a blower 46 and sieves 48, 50 with louvers, also known as a sieve/chaffer, a sieve, or a chaffer. The sieves 48, 50 can be oscillated in a fore-and-aft direction. The clean crop routing assembly 28 removes the MOG and guides grain over a screw conveyor 52 to a grain elevator 53. The grain elevator 53 deposits the grain in the grain tank 30, as shown in FIG. 1. The grain in the grain tank 30 can be unloaded by means of an unloading screw conveyor 32 to a grain wagon, trailer, or truck, for example.

Harvested crop remaining at a rear end of the sieve 50 is again transported to the threshing assembly 26 by a screw conveyor 54 where it is reprocessed by the threshing assembly 26. Harvested crop remaining at a rear end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60.

The crop debris routing assembly 60 includes a chopper housing 72 and a chopper rotor 74 arranged in the chopper housing 72, collectively identified as a chopper 73. The chopper rotor 74 rotates, for example, in a counter-clockwise direction about an axis that extends, for example, perpendicular to the forward operating direction. The chopper rotor 74 includes a plurality of chopper knives 76 that are distributed around a circumference of the chopper rotor 74. The crop debris routing assembly 60 further includes opposing knives 78 that are coupled to the chopper housing 72 and extend toward the chopper rotor 74. The chopper knives 76 of the chopper rotor 74 cooperate with the opposing knives 78 to chop the straw into smaller pieces.

One or more spreaders are provided downstream of an outlet 80 of the crop debris routing assembly 60. One spreader 82 is shown in FIG. 1. The spreader 82 may include a number of impeller blades 84, each of which is connected to a disk 86 that rotates about a central axis 88. The impeller blades 84 extend downwardly from the disk 86 and, for example, radially outwardly from the central axis 88. The disk 86 and the impeller blades 84 coupled thereto are rotatably driven by a motor 90 that may be for example, a hydraulic motor. Chopped straw is moved through the outlet 80 of the crop debris routing assembly 60 to the spreader 82. Rotation of the impeller blades 84 of the spreader 82 spreads the chopped straw as it exits the agricultural machine 10.

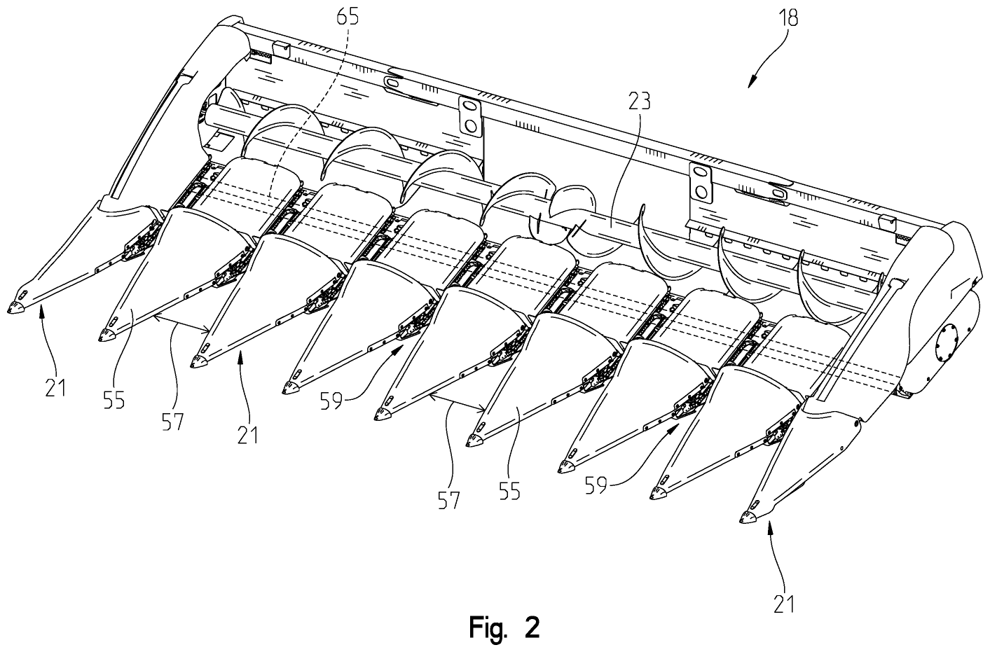

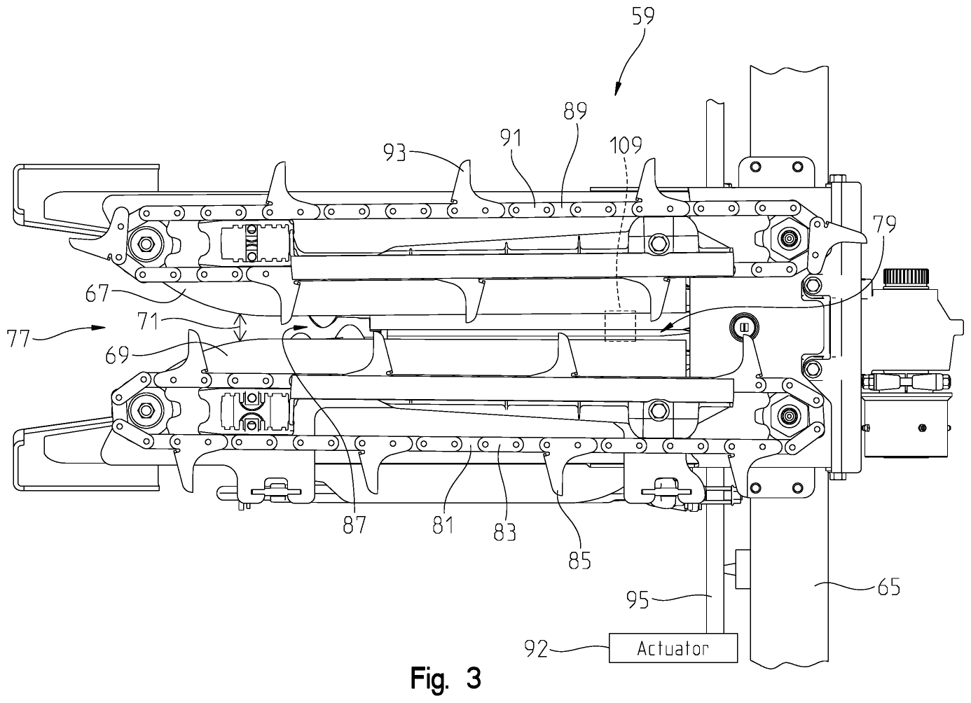

As further illustrated in FIG. 2, the corn header 18 includes a plurality of crop row dividers 21 and a crop auger assembly 23 each coupled to a frame 65. Each of the crop row dividers 21 includes a cone-shaped nose 55, wherein a space 57 is defined between adjacent noses 55. The space 57 is generally aligned with a corn row by the operator or by an automatic guidance system that directs the agricultural machine 10 along a row of corn. As the agricultural machine 10 moves forward, the corn stalks are directed by the nose 55 to a deck assembly 59 as illustrated in FIG. 3.

As shown in FIG. 3, the deck assembly 59 includes a first deck plate 67 and a second deck plate 69 spaced from the first deck plate 67 by a gap 71. The corn stalks enter the space 57 and are directed by the adjacent noses 55 into the gap 71. The gap 71 extends from a first end or front 77 to a second end or rear 79 of the deck assembly 59. The gap 71 is adjustable to adjust the spacing between the first deck plate 67 and the second deck plate 69.

A first gathering chain assembly 89 is disposed above the first deck plate 67 and includes a plurality of links 91 one of which include paddles 93. A second gathering chain assembly 81 is disposed above the second deck plate 69 and includes a plurality of links 83, some of which are paddles 85. As the stalks move through the gap 71 from the first end 77 to the second end 79, a stalk roll assembly 87 captures the stalk and pulls each stalk toward the ground. The corn stalk is pulled downward toward the first deck plate 67 and the second deck plate 69, whereupon a corn ear makes contact with the deck plates 67 and 69 as the corn ear is separated from the stalk.

In some implementations, the deck assembly 59 includes a linkage assembly (not shown) coupled to one or both of the first deck plate 67 and the second deck plate 69. The linkage assembly is coupled to the second deck plate 69, and a rod 95 is coupled to an actuator 92. In one implementation, the rod 95 is an arm of the linkage assembly driven by the actuator 92 to move one or both deck plates 67, 69 relative to each other to vary a width of the gap 71 between the deck plates 67, 69. Thus, the actuator 92 causes movement of one or both of the first deck plate 67 and second deck plate 69, to widen or narrow the gap 71

Once the ears of corn are removed from the corn stalk by the deck assembly 59, crop material including ears of corn, with or without husks, as well as corn cobs, corn husks, and chaff, move through the agricultural machine 10 for further processing to deliver kernels of corn separated from the cobs. Before the kernels are moved to the grain tank 30, crop materials, other than the kernels, including non-grain material such as the corn cobs, corn husks, and chaff, i.e., crop residue, are separated from the crop material and deposited on the ground which protects the soil from erosion and which returns the plant matter to the soil. While this residue provides a useful function once deposited on the ground, an understanding of each of the various non-grain material elements of the crop material, which includes the residue, is beneficial for controlling the operation of crop processing devices.

For instance, a measurement of a corn cob size prior to kernels being stripped, i.e., the total ear, which may or may not include the husk, can be used to control the operation of crop processing devices. This measurement, in one implementation, includes an identification of the dimensions of the ears of corn and the dimensions are used to identify the size of the corn and other crop material to provide information for controlling the operation of the crop processing devices. For instance, the identified dimensions of the ears of corn include, but are not limited to, the length of the corn ear, the width of the corn ear, the diameter of the corn ear, the length of the corn cob, and the diameter of the corn cob.

Other harvesters for harvesting other types of crops are also contemplated. For instance, harvesters for legumes process the harvested crop materials to provide legumes and crop residues that include non-grain material elements, such as to straw, stems, and pods. Legumes include but are not limited to soybeans and peas. Dimensions of these legumes and the legumes crop residues are used, in one or more implementations, to control the crop processing assemblies or mechanisms for such harvesters. In other implementations, grain crops such as wheat are harvested by the agricultural machine 10 when configured to harvest wheat. In the case of wheat, the harvested crop material includes grains of wheat, grain heads, hulls, straw, or stems. In one example of these types of combine harvesters, the crop is moved by a reel that forces the crop across a cutterbar that severs the crop from the ground. The cut crop is directed to a conveyor that moves the cut crop to the crop processing devices for separating and cleaning grain including legumes from the cut crop which includes, but is not limited, to a threshing cylinder, a threshing basket, a sieve, a chopper, a spreader, and an auger that delivers the grain or legumes to a grain tank. As described herein, both the reel and the corn header collect crops for cutting and each is considered to be a collecting apparatus.

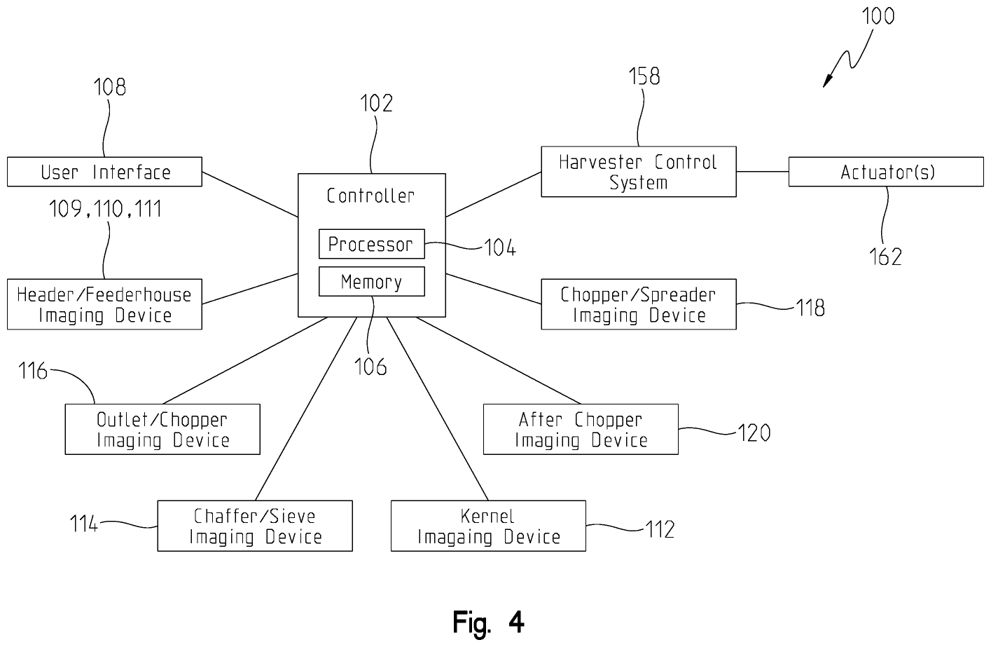

As seen in FIG. 4, a control system 100 includes a controller 102 to control harvesting automation systems based on images of the harvested crop materials. In the case of harvesting corn, complete ears of corn, the bare cobs, the kernels of corn, and other crop materials, are identified. As seen in FIG. 4, the controller 102 is operatively connected to one or more imaging devices each of which is positioned at various locations of the agricultural machine 10. Each of the imaging devices is positioned along a flow of the corn harvesting operations to capture electronic images of the crop material which includes but is not limited to complete ears of corn, the bare cobs, kernels, the crop residue being deposited, and the kernels removed from the cobs.

The controller 102, in different implementations, is a single controller or a plurality of controllers, which may be operatively coupled to one another. As shown in FIG. 4, the controller 102 includes a memory 104 and a processor 106 configured to execute instructions (i.e. algorithmic steps) stored on the memory 104. The controller 102 may be operatively coupled (i.e. hardwired or connected wirelessly) to other components of the agricultural machine 10. If hardwired, the controller 102 may be connected to the components via wires, and if connected wirelessly, the controller 102 may be connected to the components via Wi-Fi, Bluetooth, NFC, or other known means of wireless communication. Thus, the controller 102 may be positioned on the agricultural machine 10 or positioned remotely, away from the agricultural machine 10.

The controller 102 executes or otherwise relies upon computer software applications, components, programs, objects, modules, or data structures, etc. Software routines, resident in the included memory 106 or other memory, are executed in response to the signals received from the sensors as well as information received from the transmitter/receiver. In other implementations, the computer software applications are located in the cloud. The executed software includes one or more specific applications, components, programs, objects, modules or sequences of instructions typically referred to as “program code”. The program code includes one or more instructions located in memory and other storage devices that execute the instructions that are resident in memory, which are responsive to other instructions generated by the system, or which are provided by a user interface 108. The processor is configured to execute the stored program instructions.

The controller 102 is operatively connected to the user interface 108 which, in one implementation, is located in the cab 16. The user interface 108 is operatively coupled to the controller 102 such that a user operates the harvester and its functions through the user interface 108. The user interface 108 includes one or more user inputs for the user to input data into the memory 106 of the controller 102. As described below, in some implementations, the user interface 108 is used by the operator to provide an adjustment input to the controller 102. In this implementation, the operator has the option of manually adjusting the harvesting components based on images of crop material displayed on the user interface 108.

The control system 100 is operatively connected to a plurality of imaging devices, each of which captures or produces images of the crop material being harvested. Each of the imaging devices captures images at different stages of the harvesting process. The images at one or more different stages of the harvesting processes are used to control automation features of harvesting devices and harvesting assemblies. Imaging devices include but are not limited to radar, LiDAR, thermal imaging devices, infrared imaging devices, and cameras, including still image cameras and moving imaged cameras, for instance video cameras.

For instance, a crop imaging device 110 is operatively connected to the controller 102 of FIG. 4. As seen in FIG. 1, the crop imaging device 110 is located at the header 18. In one implementation, a crop imaging device 110 is located at the auger 23. In another implementation, a crop imaging device 109 is located at the gap 71 of the deck assembly 59. In other implementations, the imaging device 109 is located at an output of the deck assembly 59. Other locations are contemplated. In still other implementations, a crop imaging device 111 is located at the feederhouse 20. As the crop material moves along the deck assembly 59, the imaging devices 109, 110, or 111 take images of the crop material to identify crop elements found in the crop material, including both grain material elements and non-grain material elements. The illustrated locations of imaging devices 109, 110, and 111 indicate general locations of these imaging devices. For instance, by stating that imaging device 109 is at the auger in FIG. 3, it is technically further behind the deck assembly and toward the right side of FIG. 3. In addition, the position of imaging device 111 in FIG. 1 on the feederhouse 18 is further behind the deck assembly.

In different implementations, the agricultural machine 10 identifies one or more crop elements which are included in the crop material. When corn is being harvested, the crop elements of the crop material moving past the imaging devices 110 and/or 111 include corn cobs with most kernels of corn or with some kernels of corn, the bare cobs, either complete or partial, the kernels of corn separated from the cob, the crop residue, and complete or partial ears of corn with none, some, or all the husks. While two imaging devices are described for use at the header 18, the header 18 in other implementations includes one or more imaging devices or multiple imaging devices located at an appropriate location or locations within the header. In another implementation, the header 18 does not include an imaging device and one or more imaging devices, as described herein, are placed at other locations within the agricultural machine 10. As used herein, corn cobs refer to one or more of the above including corn cobs with most kernels of corn, with some kernels of corn, and bare cobs, either complete or partial. Corn cob size includes complete corn cobs or partial corn cobs that have been broken into small pieces during or after harvesting.

For harvesting corn, the ears of corn can be subjected to harsh conditions resulting from the mechanical processing of the crop material to provide the kernels. The conditions of mechanical processing, however, are controlled by mechanical adjustment to the processing devices or assemblies. By identifying the type of elements of the crop material and the sizes of those elements, the processing devices are adjusted to reduce the amount of kernels that are either lost or damaged during the flow of crop material through the harvester. In different implementations, the position or speed of the processing device is adjusted. For instance, kernels of corn may fall off or be removed from the cob without being captured during the harvesting process. To increase the amount of harvested kernels, images of the corn cobs, and/or kernels, or other crop residue are analyzed. Results of the analysis are used to adjust the processing devices to reduce the number of kernels that may be lost during a harvesting operation.

The imaging devices 110 and/or 111 are configured to image of the ears of corn and other crop materials that are being harvested and which move past the imaging devices 110 and/or 111. In one implementation, the imaging devices take a series of individual and successive images of the crop material which includes a number of different crop elements before or after separation from the stalk. In another implementation, the imaging devices take a continuous image, e.g. a moving picture, of the crop elements as the ears move past the imaging devices. The output of the imaging devices is interfaced with the controller 102 and transmits the images to the controller which processes the images with the processor 104. The processor 104 accesses imaging analysis software stored in the memory 106 which identifies elements of the crop material moving past the imaging devices.

The crop material moving past the imaging devices 110 or 111 may include the bare cobs, the kernels of corn, the crop residue, and complete or partial ears of corn with none, some, or all the husks. In different implementations, the controller 102 is configured to identify some of the crop elements that may not include all of the crop elements of the crop material. In one implementation, only those crop elements are identified which are considered to provide necessary information to adjust the gap 71. For instance, while the crop elements include crop residue, such as straw, stems, leaves, husks, these elements are not identified in one implementation, since the identification of the elements may not provide information needed to adjust the processing devices.

The processor 104 identifies different types of elements of crop material based on the characteristics of each of the crop elements located in the crop material. The characteristics include, but are not limited to dimensions, such as length, width, and diameter, color, and shades of gray ranging from black to white. Initially, in one implementation, the processor identifies the types of elements of the crop material. After being identified, or at substantially the same time as being identified, the processor identifies the sizes of the identified crop elements.

To determine the identity of different crop elements, the images, which include arrays of pixels, which in one implementation are analyzed based on groupings of pixels of the same size, type, color, or shades of gray. For instance, an image of an ear of corn includes image attributes such length, width, or diameter of the ear of corn, as well as shades of gray ranging from black to white. By identifying these sizes, shapes, and grayscale attributes of groupings of pixels, the identity of the crop elements is determined. In other implementations, the imaging devices are color imaging devices and an analysis of color images provides identification of the crop elements.

In one implementation, characteristics of crop elements is stored in the memory 106 which includes a database of characteristics. The processor 104, using the imaging software, identifies the characteristics of imaged crop elements which are compared to the stored characteristics of crop elements. This comparison determines the identity of the crop elements which includes, but is not limited to an ear of corn, a corn cob, a kernel of corn, pods, and crop residue such as straw, stems, and leaves. Once the identity of the crop elements is determined, the sizes of the identified crop elements are determined. For instance, the size of a corn cob element provides useful information to determine whether the gap of deck assembly 59 should be adjusted to improve the harvesting process. In another implementation, the size of a corn cob element is used to adjust the gap at the thresher basket 43. For instance, the controller 102 transmits a signal to the actuator 92 which adjusts the gap 71 between the first deck plate 67 and second deck plate 69. In one or more implementations, a database includes a range of sizes and each of the sizes references a preferred setting of one of the processing devices based on the size. For instance, a corn cob having a certain size references a setting of the gap 71.

The agricultural machine 10 includes one or more additional imaging devices, each of which takes and transmits images to the controller 102 to control the adjustment of one or more crop processing arrangements or components. For instance, in one implementation, the gap 71 is adjusted based on images of the kernels of corn by a kernel imaging device 112 located at the clean grain elevator 53. The clean grain elevator 53 moves the grain to a storage bin. As described herein, the clean grain elevator 53 is considered a processing device to deliver grain. The imaged kernel or imaged kernels provide information that is used to adjust one or more of the processing systems, including but not limited to the threshing basket of the threshing section 42, the sieve/chaffer 48, the deck assembly 59, and the chopper 73. Consequently in one or more implementations, images of crops and crop residue taken by one of the imaging devices at one location are used to adjust a crop processing device where that imaging devices is not located or where a different imaging device is located. As described herein, the crop processing devices include, but are not limited to, the feederhouse 20, the clean crop routing assembly 28, the thresher basket 43, sieves 48, 50, the clean grain elevator 53, the chopper 73, and the spreader 82.

In one implementation, the processor identifies the sizes of the kernels of corn, the sizes of the corn cob, or both which are used to determine a total diameter or the ear of corn. Because each of the kernels that extend from the corn cob are in contact with adjacent kernels, the size of the kernels provides a total diameter of the corn cob. In a further implementation, the size of the kernels plus the size of the cob is used to determine a size of an ear of corn. For instance, the complete cob size plus two (2) times a kernel size is used to determine a size of an ear of corn while the kernels are still attached to the cob. In a further implementation, when harvesting beans, the size of the bean pod is used to estimate the size of the beans and the harvesting equipment is adjusted accordingly. In another implementation, the size of the beans is used to determine the size of the bean pod.

Using the kernel size, the processor 104 accesses kernel size data and diameter data stored in memory to determine one or more of ear size, kernel size, and cob size. For instance, in some circumstances, known kernel sizes are used to identify cob size or to identify ear corn size. By determining harvested kernel sizes and comparing those sizes to known kernel sizes, the size of a corn cob can be determined. In other implementations, the kernel sizes are measured after being removed from the cob to determine corn cob size based on images taken of the kernel by imaging device 112. In both of these implementations, the gap 71 is adjusted by the controller 102 based on one or more corn cob size or kernel size.

In another implementation, the imaging device 111 images the complete ear of corn lacking husks when moving through the feederhouse 20. The imaging device 111 transmits the images of the ears of corn moving through the feederhouse 20 to the controller 102. Upon receipt of the images, the processer 104 utilizes the imaging software to determine dimensions of corn ears based on a full size ear of corn, and in some cases based on a full size ear of corn that is missing some kernels or parts of the cob. In different implementations, the kernel size and imaged corn ear size are used either alone or in combination to identify corn cob size.

Further implementations include one or more of the imaging devices 109, 110, 111, and 112, as well as one or more of a sieve imaging device 114, a chopper inlet area imaging device 116, a chopper/spreader imaging device 118, and a residue discharge imaging device 120. Each of the imaging devices is disposed at one of these crop processing devices to provide images of one or both of grain material or non-grain material that is being processed. Spreaders, choppers, and other crop residue processing devices are considered processing devices as described herein.

In one or more implementations, images taken by one of the imaging devices located at one of the processing devices are used to a adjust a processing device where the imaging device is not located. For instance, an imaging device located at the clean grain elevator 53 images kernels of corn which are identified by the processor. The controller, using the identified kernels, does not adjust the clean grain elevator, but instead adjusts a different one of the more of the processing devices. For example, the controller adjusts the threshing basket only. In other implementations, the controller adjusts one or more of the processing devices but not the grain elevator. In still other examples, all of the processing devices are adjusted.

Imaging device 114 is supported by the frame of the harvester and is focused on interior regions of agricultural machine 10 so as to capture images of crop residue being blown from the clean crop routing assembly 28. Imaging device 116 is supported by the frame of the agricultural machine 10 to capture images of crop residue moving at an outlet of threshing assembly 26. Imaging device 118 is supported by the frame of agricultural machine 10 to focus on interior regions of agricultural machine 10 at chopper 73. Imaging device 120 is supported by the frame of the agricultural machine 10 at a rear of agricultural machine 10 and at, near, or after the chopper 73. Imaging device 120 is supported so as to be focused on the crop residue that is being discharged onto the ground.

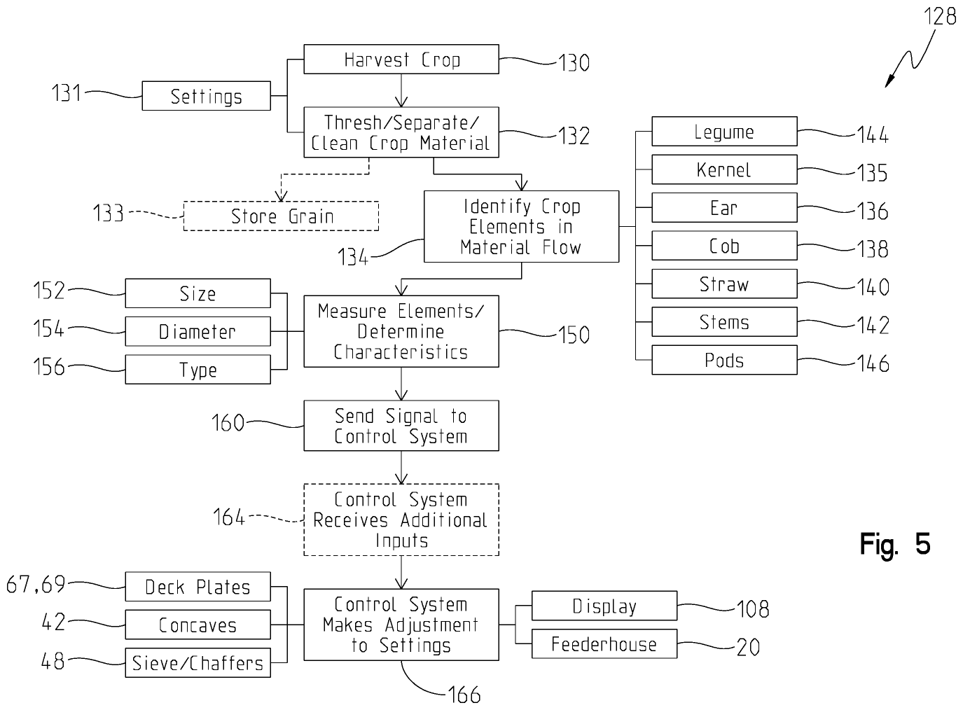

FIG. 5 illustrates a block diagram 128 of a process to adjust the positions of grain processing devices including the deck plates 67, 69, the threshing basket of the threshing section 42, and the sieve/chaffers 48, 50 of the clean crop routing assembly 28. Initially at block 130, the harvesting of crop begins. While harvesting the crop, the crop is threshed, separated, and cleaned at block 132 based on settings 131 of the crop processing devices. As a result of the threshing, separating, and cleaning the grain, or other crop types, for example, the grain or legumes are stored in a bin or other storage location at block 133.

Initially, each of the processing devices of FIG. 1 is set to a predetermined processing setting to begin the processing of the crop to extract the grains or legumes from the plant. As the crop is being processed, the crop material flows past each of the one or more imaging devices 109, 110, 111, 112, 114, 116, 118, and 120. As described above, the controller 102 identifies the elements of the crop material in the material flow at block 134. Depending on the location of the imaging device on the agricultural machine 10, the controller identifies the crop elements including one or more of the kernels 135, the ear of corn 136, the cob 138, the straw 140, the stems 142, legumes 144, or pods 146, when harvested. Once the crop elements are identified at block 134, characteristics of the crop elements are determined at block 150 by the controller 102. The crop characteristics include size, such as length and width, at block 152, diameter at block 154, and type at block 156. The crop characteristics also include identification of whole or complete elements as well as portions of elements, such as split and half portions. By identifying these types of elements, the measured elements are identified by the processor to determine sizes of elements. Once determined at block 150, the controller 102 transmits control signals to a control system 158 of FIG. 4 at block 160.

In one implementation, the control system 158 is operatively connected to one or more actuators 162, each of which adjusts the positions one or more of the processing devices including the deck plates 67, 69, the threshing basket of threshing section 42, and the sieve/chaffer 48, 50 as needed to optimize threshing, separating, and cleaning at block 132. For instance, actuator 92 adjusts the gap 71 of the deck plates 67 and 69. The control system 158 may receive additional inputs at block 164. Such additional inputs include but are not limited to feed rates, moistures, or operational targets for crop loss or crop quality. The signals transmitted by the control system 158 make adjustments to the actuators 162 (see FIG. 4) at block 166. In one implementation, the control system 158 communicates with actuators 162 over the harvester CAN bus. The actuators are used to adjust processing positions of each of the associated processing devices. The controller 102 determines a current processing position and then adjusts the current processing position to a new processing position based the image analysis. For instance in some implementations, a clearance of the threshing basket is adjusted, a clearance of the sieve is adjusted, or the gap between deck plates is adjusted.

While the imaging devices are generally located at one or more of the processing devices, in one implementation, images taken at one processing device are used to adjust the position or speed or both of one or more other processing devices. In other implementations, the imaging devices are placed at locations other than a processing device. For instance, images taken by the imaging device 112 are used, in some implementations, to control the operation of the deck plates 67 and 69. In other implementations, an imaging device located at one processing device is used to control the operation of the processing device at which the imaging device is located.

A display 170 is operatively connected to the control system 158 and displays the status of one or more of the deck plates 67, 69, the threshing basket of threshing section 42, and the sieves/chaffers 48, 50. The operating status includes but is not limited to the effectiveness of the threshing/separating/cleaning operations. This status information enables the operator to determine whether the systems are operating appropriately. In different implementations, the display 170 includes control actuators for manually adjusting positions or speeds of the processing devices, a display of element size information, or a display of recommended settings for positions or speeds of the processing devices. In one implementation, for instance, the display includes override controls to enable the operator to override the automatic control of the threshing basket or sieve. In this implementation, the operator adjusts the clearance of one or both if desired. In another implementation, the display provides real time images received from each of the imaging devices to enable the operator to make manual adjustments to the processing devices based on images. In this instance, the automatic control of the processing devices is overridden by the operator who then makes manual adjustments.

While exemplary implementations incorporating the principles of the present disclosure have been described herein, the present disclosure is not limited to such implementations. For instance, while a harvester for grain has been described in detail, other harvesters for crops, are included and include the features described. Consequently, this application is intended to cover any variations, uses, or adaptations of the disclosure using its general principles. Further, this application is intended to cover such departures from the present disclosure as come within known or customary practice in the art to which this disclosure pertains.

1. An agricultural machine comprising:
a plurality of processing devices, wherein each of the processing devices is configured to process crop material including non-grain material;
one or more imaging devices each configured to image the non-grain material at one or more of the plurality of processing devices;
a controller operatively connected to the one or more imaging devices, the controller comprising a processor and a memory, wherein the memory is configured to store program instructions and the processor is configured to execute the stored program instructions to:
image the non-grain material with the one or more imaging devices;
identify a characteristic of the imaged non-grain material to identify non-grain material elements;
determine a position of one of the plurality of processing devices; and
adjust the position of the one of the plurality of processing devices based on the identified non-grain material elements and the determined position of one of the plurality of processing devices.

2. The agricultural machine of claim 1, wherein the imaged non-grain material elements comprise grain carriers.

3. The agricultural machine of claim 2, wherein the grain carriers comprise at least one of a cob, a pod, or a hull.

4. The agricultural machine of claim 2, wherein the processor is configured to execute the stored program instructions to identify at least one of a color or shades of gray ranging from black to white or to identify dimensions of the grain carriers including at least one of length, width, or diameter.

5. The agricultural machine of claim 2, wherein the processing devices comprise at least one of deck plates, a threshing basket, a sieve, or a crop residue processing device.

6. The agricultural machine of claim 5, wherein the one or more imaging devices comprises a sieve imaging device configured to image the grain carriers at the sieve.

7. The agricultural machine of claim 2 wherein the processor is configured to execute the stored program instructions to identify corn cob elements of the identified grain carriers.

8. The agricultural machine of claim 7, wherein the processor is configured to execute the stored program instructions to adjust a position of one or more of the deck plates, the threshing basket, or the sieve based on the identified corn cob elements.

9. The agricultural machine of claim 2, wherein the one or more imaging devices comprises a crop residue imaging device located at the crop residue processing device to image corn cob elements of the imaged grain carriers.

10. The agricultural machine of claim 9, wherein the processor is configured to execute the stored program instructions to identify the imaged corn cob elements.

11. The agricultural machine of claim 10, wherein the processor is configured to execute the stored program instructions to adjust a position of one or more of the deck plates, the threshing basket, or the sieve, based on the identified corn cob elements.

12. The agricultural machine of claim 4, wherein one of the one or more imaging devices is located at a clean grain elevator and is configured to image at least one of kernels or corn cobs.

13. The agricultural machine of claim 12, wherein the processor is configured to execute the stored program instructions to identify sizes of the at least one of kernels or sizes of the corn cobs.

14. The agricultural machine of claim 13, wherein the processor is configured to execute the stored program instructions to adjust a position of a threshing basket based on at least one of the identified kernel size or the identified corn cob size.

15. The agricultural machine of claim 13, wherein the processor is configured to execute the stored program instructions to adjust the position of the deck plates processing device based on at least one of the identified kernel size or the identified corn cob size.

16. A method of adjusting processing devices of an agricultural machine to separate and clean crop material from a harvested crop comprising:
imaging crop material comprising grain material and non-grain material;
identifying characteristics of the non-grain material to identify the non-grain material elements;
determining a position of the one or more of the processing devices of the agricultural machine; and
adjusting the position of at least one of the one or more processing devices based on the identified non-grain material elements.

17. The method of claim 16, wherein the identified non-grain material elements comprise identified carrier elements.

18. The method of claim 17, wherein the identified carrier elements comprise corn cob elements, wherein the corn cob elements are identified as one of full cobs, portions of cobs, and split cobs.

19. An agricultural machine comprising:
one or more processing devices for separating and cleaning grain;
an actuator coupled to at least one of the one or more processing devices;
an imaging device disposed at one of the one or more processing devices, the imaging device configured to image crop material comprising grain material and non-grain material;
a controller operatively connected to the imaging device and to the actuator, wherein the controller is configured to:
identify characteristics of the imaged grain material to identify grain material elements and the imaged non-grain material to identify non-grain material elements;
determine a position of the one or more processing devices; and
adjust the position of the one or more processing devices based on the identified grain material elements or the identified non-grain material elements.

20. The agricultural machine of claim 19, wherein the grain material elements comprise at least one of ears of corn or kernels of com and the non-grain material elements comprise com cobs.
